(19) United States
(12) Patent Application Publication
(10) Pub. No.: US 2003/0126748 A1
(43) Pub. Date: Jul. 10, 2003

(54) Multifunction folding tool

(76) Inventor: Maurice Cachot, Delemont (CH)

Correspondence Address: BLANK ROME COMISKY & MCCAULEY, LLP, 900 17TH STREET, N.W., SUITE 1000, WASHINGTON, DC, 20006, US

(21) Appl. No.: 10/298,555

(22) Filed: Nov. 19, 2002

(30) Foreign Application Priority Data
Jan. 9, 2002 (EP) EP02405008.0

(51) Int. Cl. B26B 13/00

(52) U.S. Cl. 30/255

(57) ABSTRACT

Multifunction folding tool comprising at least one two lever instrument that can close and open by the rotation of one of the two levers and whose said lever is firmly held in a resting position when said instrument is open, thus increasing the convenience of use and the security of the tool.

### BACKGROUND OF THE INVENTION

1. Field of the Invention

The present invention concerns a multifunction folding tool comprising a two-lever instrument, whose first lever is constituted by the sides of the multifunction tool and whose second lever also serves to unfold and refold said instrument.

2. Background of the Related Art

Multifunction folding tools are mostly folding pocket knives whose handle serves to accommodate the folded blade as well as one or several other instruments fulfilling various functions such as corkscrew, screwdriver, cap lifter, reamer, scissors etc. All these instruments are at least partially folded in the tool's handle and can be unfolded independently one from the other according to the use one wishes to make of the tool.

One type of instruments usually included in the folding tools, apart from the knife blades, are instruments having two articulated levers actuating for example blades or jaws, such as scissors, pincers, secateurs etc. There are many designs of such folding instruments, different in their function, size, folding mechanism and especially convenience of use.

U.S. Pat. No. 6,065,213 describes for example folding scissors integrated to a multifunction pocket tool whose first lever is constituted by the tool's body and which unfolds by the second lever rotating with respect to the first lever. The rotational movement of the second lever must however be initiated by pressing on a small ear close to the rotation axis. The ear's small size requires that a nail or small tool be used to initiate the unfolding of the scissors and its position close to the rotation axis requires the exertion of a relatively substantial force to generate the necessary rotational movement. There is furthermore a risk of the tool unfolding during transportation with other tools or storage in a pocket or sheath. Furthermore, when the scissors are unfolded, the position of the second lever is not accurately determined. The user must thus ensure before each use that the relative position of both levers allows him to grasp the scissors correctly. An additional disadvantage of the scissors as described in this patent is the mechanism generating the force moving the blades apart when the scissors are used. It is a fragile and relatively complicated mechanism, constituted by a rotating part actuated by a spring and pressing against one of the two blades.

Patent EP-A1-714736 describes a folding tool with two levers, of which the preferred embodiment is a secateur whose first lever is constituted by the tool's handle and which is unfolded and refolded by rotating the second lever. The force moving the blades apart is generated by dorsal spring blades sturdier than the aforementioned spring mechanism. In this case also there is however a risk of the secateur unfolding accidentally. Similarly, when the instrument is unfolded, the position of the second lever is not accurately determined. The user must thus ensure before each use that the relative position of both levers allows him to grasp the scissors correctly. Another disadvantage of this tool resides in the blade-driving mechanism being through the second lever. The blade is in fact driven through a pin perpendicular to it and which is inserted, during the tool's assembly, into a rail fashioned in the second lever. Mounting the pin into the blade thus requires an intermediary operation between the manufacture of the blade and the assembly of the tool, therefore increasing the production costs.

### SUMMARY OF THE INVENTION

It is an aim of the present invention to propose a multifunction folding tool comprising at least one two-lever instrument, whose first lever is constituted by the tool's handle and whose folding and unfolding can be effected by operating only a handle provided at the end of the second lever.

It is another aim to propose a multifunction folding tool comprising at least one two-lever instrument offering optimum security against involuntary opening and closing, thus improving also the convenience of use.

It is another aim to propose a multifunction folding tool comprising at least one two-lever instrument whose production requires minimal handling.

According to the present invention, these aims are achieved by a folding tool as described in the first independent claim of the present application. The folding two-lever instrument comprised in the tool according to the present invention unfolds and refolds easily by actuating a handle fashioned at the end of the second lever. The security and convenience of use are ensured by a mechanism holding firmly the second lever in a first resting position when the instrument is folded and in a second resting position when the instrument is unfolded. All the parts constituting the two-lever instrument comprised in the preferred embodiment of the tool according to the present invention, apart from the rivets, are stamped from a metal sheet and then folded for certain, thus enabling a low-cost production of parts having highly elaborated shapes.

### BRIEF DESCRIPTION OF THE FIGURES

The present invention will be better understood with the aid of the FIGS. 1 to 13 illustrating, by way of explanatory but not limiting example, the preferred embodiment of the invention. In this embodiment, the multifunction folding tool is a pocket knife comprising a two-lever instrument constituted of folding scissors such as illustrated in the FIGS. 1 to 13.

FIG. 1 is an exploded view of the folding scissors.

FIG. 2 is a side view of the closed folding scissors.

FIG. 3 is a side view of plane A of the closed folding scissors.

FIG. 4 is a side view of plane B of the closed folding scissors.

FIG. 5 is a side view of plane C of the closed folding scissors.

FIG. 6 is a side view of the open folding scissors in resting position.

FIG. 7 is a side view of plane A of the open folding scissors in resting position.

FIG. 8 is a side view of plane B of the open folding scissors in resting position.

FIG. 9 is a side view of plane C of the open folding scissors in resting position.

FIG. 10 is a side view of the open folding scissors in operating position.

FIG. 11 is a side view of plane A of the open folding scissors in operating position.

FIG. 12 is a side view of plane B of the open folding scissors in operating position.

FIG. 13 is a side view of plane C of the open folding scissors in operating position.

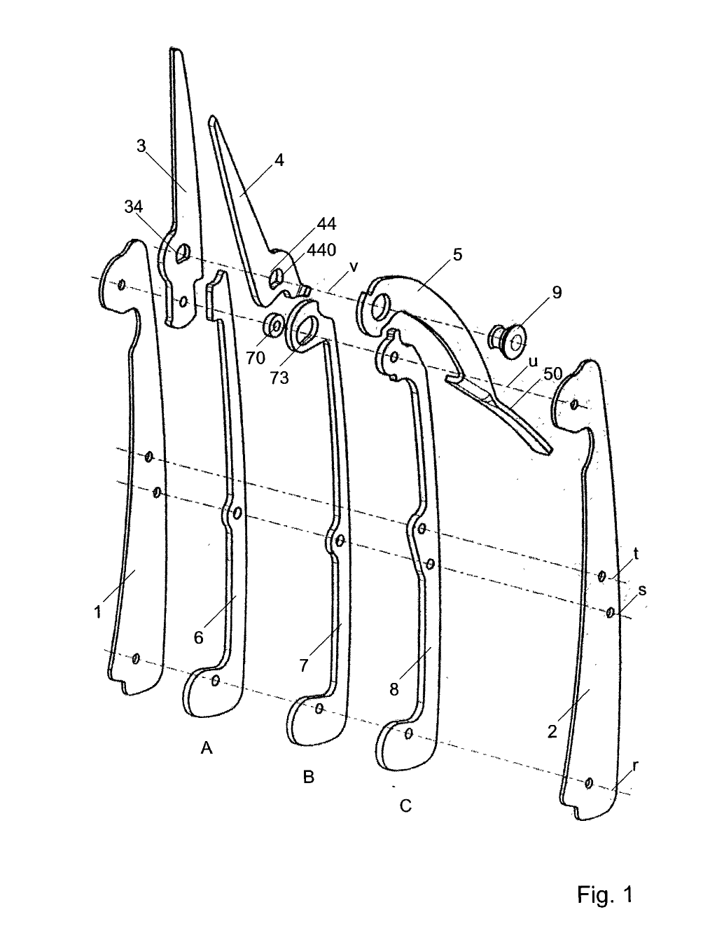

### DETAILED DESCRIPTION OF THE PREFERRED EMBODIMENTS

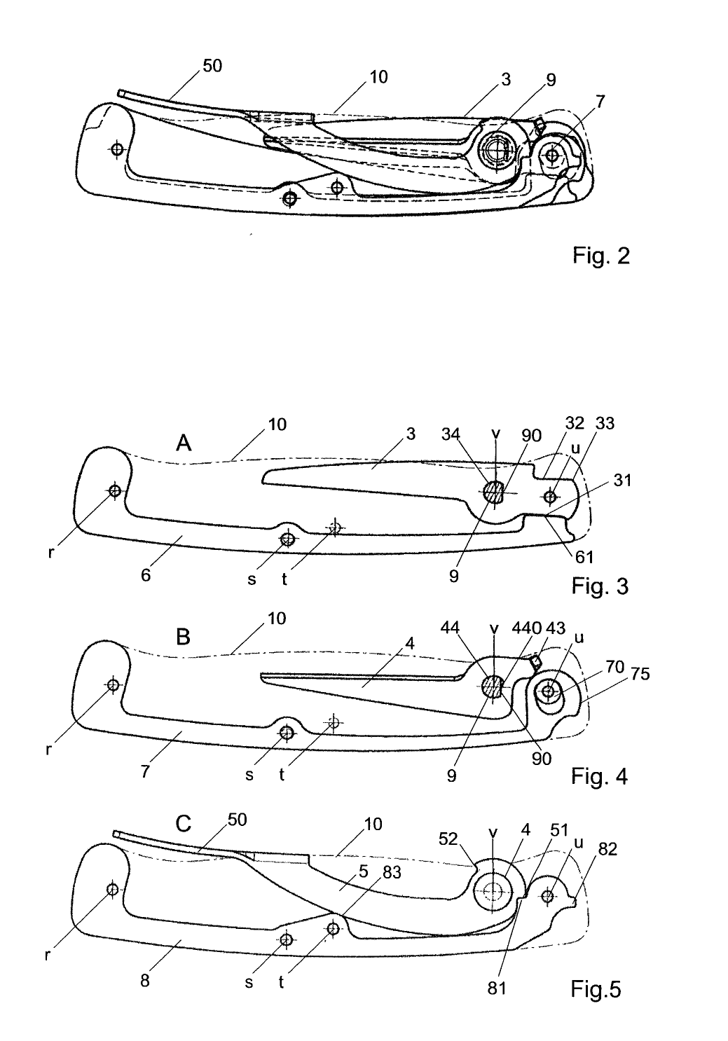

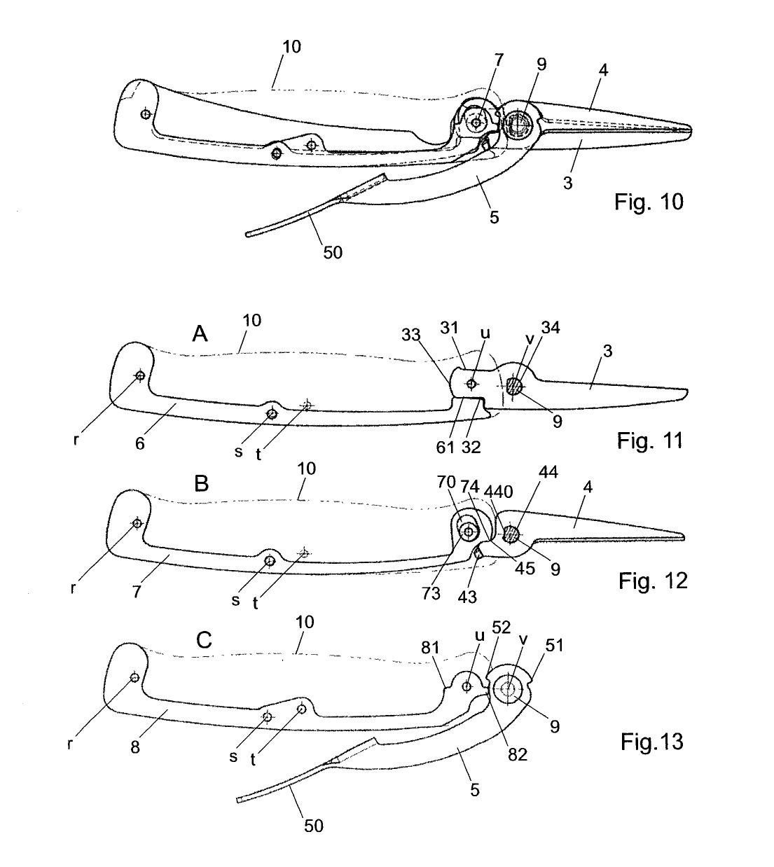

The pocket knife according to the preferred embodiment of the present invention has two sides whose periphery 10 is represented in dotted line on the FIGS. 2 to 13, constituting the knife's handle and defining an intermediate space inside which all the available instruments fold at least partially. A knife blade, the folding scissors, a cap lifter and screwdriver and a tin-opener can for example be unfolded from the front side of the pocket knife. On the knife's back there additionally are for example a corkscrew and a reamer.

The folding scissors occupy the central part of the intermediate space. Two separating element 1, 2 separate the scissors from the other instruments and prevent any friction during the opening or closing of the scissors.

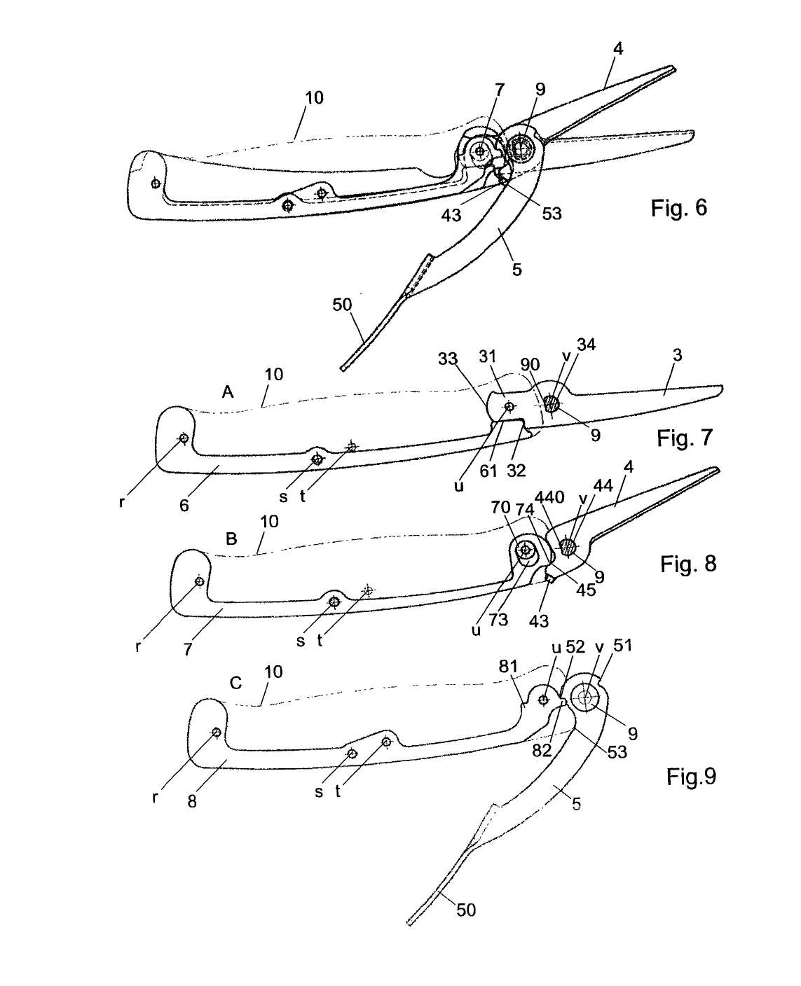

The scissors are constituted of a first blade 3 capable of pivoting around a first rotation axis u in relation to the knife's handle, the handle constituting the scissors' first lever. When the scissors are closed (FIG. 2), the first blade 3 is almost entirely folded in the intermediate space. When the scissors are open (FIG. 6), the first blade 3 is unfolded in the extension of the first lever, thus forming with it the scissors' first branch.

A second blade 4 is capable of pivoting in relation to the first blade 3 around a second rotation axis v.

A second lever 5 is capable of pivoting in relation to the first blade 3 and to the second blade 4 around the second axis v. The second lever 5 and the second blade 4 form the scissors' second branch when they are open. The extremity of the second lever is folded so as to form a handle 50 serving to make it easier to grasp said second lever 5 during the closing and opening of the scissors as well as to ensure a certain convenience of use during their operation.

A first spring element, for example a first dorsal spring blade 6, serves to hold the first blade 3 in a first fixed position when the scissors are folded (FIG. 3) and in a second fixed position when the scissors are unfolded (FIG. 7, FIG. 11), whilst allowing the first blade 3 to rotate around the first axis u during the closing and opening of the scissors. The elasticity of the first dorsal spring blade 6 is created by its being fastened only to the axes r and s. The extremity of the first dorsal spring blade 6 bearing against the first blade 3 is left free, thus allowing its movement under the exertion of a force whose intensity will depend principally on the material used and on the dimensions of the dorsal blade.

A second spring element, for example a second dorsal spring blade 7, fulfils mainly the function of applying on the second blade 4 a force moving the scissors' blades apart when these are open. The elasticity of the second dorsal spring blade 7 is generated by its being fastened to the axes r and s, similarly as for the first dorsal spring blade 6. The amplitude of the movements of the second dorsal spring blade 7 is accurately limited by a washer 70 placed around the first axis u and sliding in an oblong scalloping 73 of the second dorsal spring blade 7 when the scissors are operated.

A rigid dorsal blade 8 fastened to the axes r, s, t and u serves on the one hand to define a first accurate resting position of the second lever 5 when the scissors are closed (FIG. 5) and a second accurate resting position of the second lever 5 when the scissors are open (FIG. 9), and, on the other hand, to initiate the rotational movement of the second axis v around the first axis u when the second lever 5 has been moved out of said resting positions in order to close or open the scissors.

The back of the scissors, i.e. the back of the intermediate space comprised between the two separating elements 1 and 2 is entirely closed off by the three dorsal blades 6, 7, 8. On both sides of the scissors' back, the pocket knife comprises other dorsal blades maintaining the other instruments folded or unfolded.

A rivet 9 holds together the first blade 3, the second blade 5 and the second lever 5 and enables their relative rotation around the second axis v. The rivet 9 comprises a flattened surface 90 on parts of its length traversing the first blade 3 and the second blade 4 On the first blade 3, the opening 34 into which the rivet is inserted is of a shape identical to the rivet's edge at that place, thus preventing the rivet 9 from rotating relative to the second blade 3. The opening 44 of the second blade 4 into which the rivet is inserted has an additional indentation 440 allowing a limited rotation of the second blade 4 around the rivet 9, thus limiting accurately the distance between the blades 3 and 4.

Four rivets (not represented) placed along four axes r, s, t, u perpendicularly to the sides 1, 2 serve to keep together the elements constituting the folding scissors.

When the folding scissors are closed, the first blade 3 and the second blade 4 find themselves almost entirely in the intermediate space defined by the sides of the pocket knife (FIG. 2). The first dorsal spring blade 6 holds the first blade 3 in folded position (FIG. 3) by bearing its contact zone 61 against the first contact surface 31 of the first blade 3. The involuntary rotation of the first blade 3 around the first axis u is thus prevented by the force of the first dorsal spring blade 6. As the second blade 4 is connected to the first blade 3 by the rivet 9, it also finds itself folded back in the intermediate space defined by the knife's sides (FIG. 4). The second lever 5 is held in its first resting position through the action of the force exerted by the first dorsal spring blade 6 on the first blade 3 which, through the rivet 9, presses it until it bears against the bearing portion 83 of the rigid dorsal blade 8 and its first notch 51 is adjusted against the first ear 81 of the rigid dorsal blade 8 (FIG. 5). When the scissors are closed and, consequently, the second lever 5 is folded in its first resting position, the handle 50 is above the blades 2 and 3, thus making it easier for it to be grasped in order to open the scissors (FIG. 2).

By pulling the handle 50 with a force opposed to the force exerted by the first dorsal spring blade 6, the second lever 5 begins to rotate around the second axis v and moves out of its first resting position. When the first notch 51 bears against the ear 81, the axis v begins to rotate around the first axis u, which also moves the first blade 3 and the second blade 4 out of their respective resting positions.

The continuing of the rotational movement of the second lever 5 provokes the complete unfolding of the scissors due to the second blade 4 being driven by the second lever 5 which bears with its actuating area 53 against the lug 43 of the second blade 4. During the scissors' opening movement, the blades 3, 4 are progressively moved apart under the effect of the rounded extremity 75 of the second dorsal spring blade 7 acting as a cog guiding the movement of the second blade 4 with which it is in contact. The scissors' opening is completed when the first blade 3, driven by the second lever 5 through the second blade 4 and the rivet 9, reaches its unfolded position (FIG. 7).

Between these two fixed positions, the second blade 3 is slowed down by the force exerted by the first dorsal spring blade 6 bearing with its contact zone 61 against the rounded part 33 situated between the two plane contact surfaces 31 and 32. This mechanism increases the scissors' security and convenience of use by controlling the opening and closing movements, any intermediate position being stable.

When the scissors are open, the first blade 3 is held by the first dorsal spring blade 6 resting with its contact zone 61 against the second contact surface 32 of the first blade 3, thus preventing its involuntary rotation around the first axis u. The second dorsal spring blade 7 then exerts on the second blade 4 a force keeping it away from the first blade 3. The second lever 5 is held in its second resting position by the force applied by the second dorsal spring blade 7 through the second blade 4 and the rivet 9. The second position of the second lever 5 is determined by adjusting the second notch 52 against the second ear 82 of the rigid dorsal blade 8 (FIG. 9).

Once opened, the scissors are operated by exerting a force on the handle 50 bringing the second lever 5 towards the first lever. The second lever 5 drives in its movement the second blade 4 by bearing its actuating area 53 against the lug 43 of the second blade 4, thus acting against the force exerted by the second dorsal spring blade 7 on the second blade 4 in their contact zone 74, 45. When the pressure on the handle 50 is relaxed, the blades 2 and 3 are moved apart again under the effect of the force of the second dorsal spring blade 7.

In their preferred embodiment, the folding scissors according to the present invention use two dorsal spring blades 6, 7 and a rigid dorsal blade 8. The first dorsal spring blade 6 generates the force necessary for holding the scissors in their position when they are either folded or unfolded. The second dorsal spring blade 7 generates the force necessary for holding the blades in open position when the unfolded scissors are resting as well as the forces required for moving the blades 3, 4 apart when the scissors are used. The rigid dorsal blade 8 determines the two resting positions of the second handle 5 and initiates the rotational movement of the second axis v around the first rotation axis u. The one skilled in the art will understand that, to fulfill the same functions of positioning and of force generation, it is perfectly conceivable to modify the number and nature of the dorsal blades or to use other mechanisms.

In the preferred embodiment of the folding scissors according to the present invention, the first blade 3, the second blade 4, the second lever 5, the first dorsal spring blade 6, the second dorsal spring blade 7 and the rigid dorsal blade 8 are all stamped from metal sheets having either the same thickness in order to facilitate production or a different thickness in order to adjust the elasticity of the dorsal spring blades. The handle 50 can be formed, for example by folding the extremity of the second lever 5, by welding an additional metallic part on the second lever 5 or by duplicate molding. The lug 43 can be formed for example by folding the second blade 4 or by soldering a pin in the second blade 4. The separating elements 1, 2 are preferably stamped in a thinner metal sheet in order to limit the thickness of the folding scissors, thus limiting the thickness of the pocket knife. The manufacturing operations described here are simple operations, thus decreasing the folding scissors' production cost.

The preferred embodiment of the multifunction folding tool according to the invention comprising a two-lever instrument is constituted of a pocket knife comprising scissors. The invention's principle can however also apply to any other folding tool comprising at least one two-lever instrument actuating blades or jaws, such as pincers, secateurs, spreaders etc.

1. A multifunction folding tool comprising at least one two-lever instrument, comprising:
two lateral sides serving as a first lever to said at least one instrument and defining an intermediate space, said intermediate space serving to accommodate at least partially certain instruments in folded position,
a second lever enabling also the opening and closing of said at least one two-lever instrument,
at least one elastic element enabling said second lever to be held either in a first resting position when said two-lever instrument is folded at least partially in said intermediate space, or in a second resting position when said two-lever instrument is unfolded out of said intermediate space.

2. The multifunction folding tool according to claim 1, wherein said first and second levers of said at least one two-lever instrument actuate blades.

3. The multifunction folding tool according to claim 2, wherein said at least one two-lever instrument is constituted of scissors.

4. The multifunction folding tool according to claim 2, wherein said at least one two-lever instrument is a secateur.

5. The multifunction folding tool according to claim 2, wherein said at least one two-lever instrument is a cigar-cutter.

6. The multifunction folding tool according to claim 2, wherein said at least one two-lever instrument is a nail-cutter.

7. The multifunction folding tool according to claim 1, wherein said first and second levers of said at least one two-lever instrument actuate jaws.

8. The multifunction folding tool according to claim 7, wherein said at least one two-lever instrument is a pair of pincers.

9. The multifunction folding tool according to claim 1, wherein said at least one two-lever instrument is a spreader.

10. The multifunction folding tool according to claim 1, wherein said at least one two-lever instrument is unfolded from said intermediate space and folded into said intermediate space by rotating around a first rotation axis.

11. The multifunction folding tool according to claim 1, wherein said first and second levers of said at least one two-lever instrument are articulated around a second rotation axis.

12. The multifunction folding tool according to claim 11, wherein the pivoting of said second lever around said second axis beyond said first and second resting positions can be effected only by displacing the second axis around the first axis so as to open or close said at least one two-lever instrument.

13. The multifunction folding tool according to claim 11, wherein said second lever comprises a handle, said handle remaining accessible when said second lever is folded in its first resting position.

14. The multifunction folding tool according to claim 1, wherein said at least one elastic element is constituted of two dorsal spring blades and of a rigid dorsal blade.
